(19) United States
(12) Patent Application Publication
(10) Pub. No.: US 2024/0259357 A1
(43) Pub. Date: Aug. 1, 2024

(54) ENCRYPTED VEHICLE DATA ACCESS

(71) Applicant: Tesla, Inc., Austin, TX (US)

(72) Inventors: Thomas Dmytryk, San Francisco, CA (US); Bryan Angelo, San Francisco, CA (US)

(21) Appl. No.: 18/692,265

(22) PCT Filed: Sep. 16, 2022
(86) PCT No.: PCT/US2022/043887

§ 371 Date: Mar. 14, 2024

Related U.S. Application Data
(60) Provisional application No. 63/261,395, filed on Sep. 20, 2021.

(51) Int. Cl. H04L 9/40

(52) U.S. Cl. CPC H04L 63/0442; H04L 63/0478

(57) ABSTRACT

One or more aspects of the present disclosure relate to the configuration and management of customer data associated with a vehicle. By way of illustrative example, aspects of the present application correspond to management of data communications to obtain data client profile information generated or collected by a vehicle (e.g., “client data”). Such information can illustratively include, but is not limited, user profile information, account information, financial information, customization information, vehicle usage information, vehicle operational parameters or settings, and the like.

### CROSS-REFERENCE TO RELATED APPLICATION

This application claims the benefit of U.S. Provisional Application No. 63/261,395, entitled ENCRYPTED VEHICLE DATA ACCESS, and filed on Sep. 20, 2021. U.S. Provisional Application No. 63/261,395 is incorporated by reference herein.

### BACKGROUND

Generally described, computing devices and communication networks can be utilized to exchange data and/or information. In a common application, a computing device can request content from another computing device via the communication network. For example, a user at a personal computing device can utilize a browser application to request a content page (e.g., a network page, a Web page, etc.) from a server computing device via the network (e.g., the Internet). In such embodiments, the user computing device can be referred to as a client computing device and the server computing device can be referred to as a content provider. In another embodiment, the user computing device can collect or generate information and provide the collected information to a server computing device for further processing or analysis.

Generally described, a variety of vehicles, such as electric vehicles, combustion engine vehicles, hybrid vehicles, etc., can be configured with user specific information or configuration information to facilitate operation. In certain scenarios, a vehicle user may wish to maintain user preference, configurations or use data with allowing additional third parties to access the data. Additionally, vehicle users may wish to utilize portions of such data in various vehicles.

### BRIEF DESCRIPTION OF THE DRAWINGS

This disclosure is described herein with reference to drawings of certain embodiments, which are intended to illustrate, but not to limit, the present disclosure. It is to be understood that the accompanying drawings, which are incorporated in and constitute a part of this specification, are for the purpose of illustrating concepts disclosed herein and may not be to scale.

FIG. 1 depicts a block diagram of an illustrative environment for providing a vehicle data communication access in accordance with one or more aspects of the present application;

FIG. 2A depicts an illustrative architecture for implementing a vehicle data access service in accordance with aspects of the present application;

FIG. 2B depicts an illustrative architecture for implementing a vehicle data processing component in accordance with aspects of the present application;

FIG. 3A-3C are block diagrams of the environment of FIG. 1 illustrating the configuration and exchange of client data between clients and target vehicles;

FIG. 4 is a flow chart describing a client data generation routine for accessing vehicle data according to one or more embodiments;

FIG. 5 is a flow chart describing a vehicle data request process routine for processing a vehicle data request according to one or more embodiments; and

FIG. 6 is a block diagram illustrating a data structure for utilization in the configuration and exchange of client data between clients and target vehicles.

### DETAILED DESCRIPTION

Generally described, one or more aspects of the present disclosure relate to the configuration and management of customer data associated with a vehicle. By way of illustrative example, aspects of the present application correspond to management of data communications to obtain data client profile information generated or collected by a vehicle (e.g., “client data”). Such information can illustratively include, but is not limited, user profile information, account information, financial information, customization information, vehicle usage information, vehicle operational parameters or settings, and the like.

In certain embodiments, a user may utilize a vehicle for a fixed amount of time or in the context with a plurality of other users. For example, a user may utilize a service that allows for time-based use of a vehicle that is provided by the service. In another example, a user may be a passenger in a taxi or ride share service in which other users may be using the vehicle at the same time or in which other users may utilize the vehicle prior/after the user. In still another example, a user may be provided a vehicle rental or loaner vehicle while a primary vehicle is unavailable. In still another example, a user may share a particular vehicle with other users, such as a vehicle shared within a family, organization or other organizational criteria.

In most of the above examples, the “shared” vehicles are typically not customized or configured with a user's specific information, preferences or operational parameters. In one typical approach, the user may be able to manually enter some portion of the user specific information. This approach can be time consuming and much of the user information, may not be conducive for manual entry. For example, a user may not be aware of vehicle operational parameters or usage history specifics that can be manually entered. In another approach, a user may be able to utilize a central data repository for customization data and preference data. However, this approach requires the user to maintain user specific information with a network service, which is then accessible by the network service provider or subject to potential security or data breaches.

To address at least a portion of the above-identified inefficiencies, a network service provider can facilitate the transmission of authorized data communications between a selected vehicle and a client to allow for the utilization of user specific information, generally referred to as user profile information. The network service provider receives and maintains the user profile information in an encrypted form. The network service provider does not receive the appropriate keys to decrypt the profile information (or otherwise maintain the appropriate keys in a form) as part of the process to provide user profile information to the selected vehicle. Accordingly, the user profile information can be distributed by the network service provider without requiring manual entry of data by a user in the selected vehicle or without having the user profile information accessible to the network service provider in an unencrypted format.

Although the various aspects will be described in accordance with illustrative embodiments and combination of features, one skilled in the relevant art will appreciate that the examples and combination of features are illustrative in nature and should not be construed as limiting. More specifically, aspects of the present application may be applicable with various types of vehicle data or vehicle processes. However, one skilled in the relevant art will appreciate that the aspects of the present application are not necessarily limited to application to any particular type of vehicle data, data communications or illustrative interaction between third parties, customer and a network service provider. Further, to facilitate the exchange of encrypted data and to provide for selected customization, one or more aspects of the present application further correspond to illustrative data structure/organization in which profile information can be associated with various classes of data and sub-classes (e.g., labels) and in which individual encryption keys can be applied to different portions of the profile information.

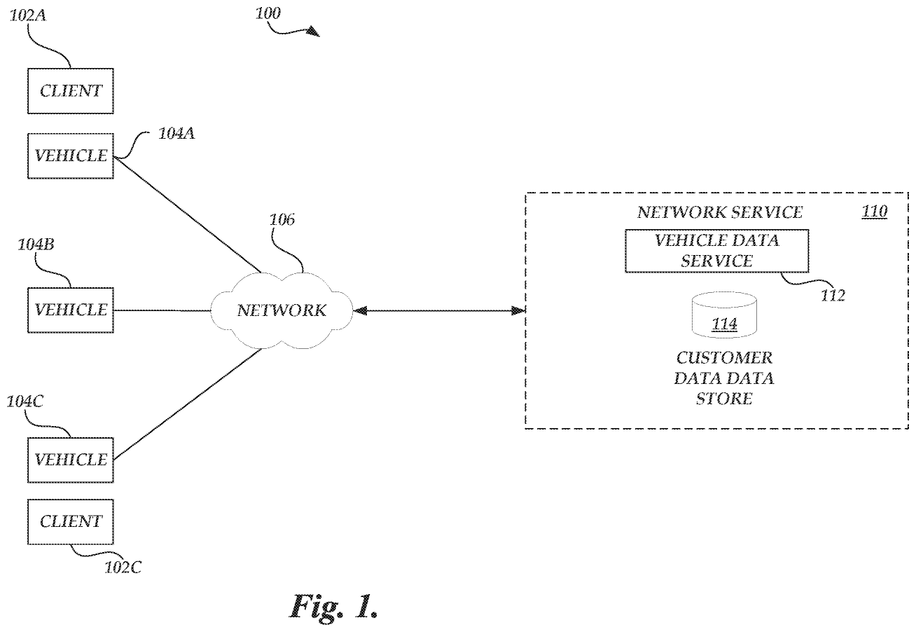

FIG. 1 illustrates an environment 100 that includes a plurality of clients 102 (e.g., clients 102A and 102B) that can access a network service. The clients 102 may generally represent an individual and one or more computing devices utilized by the individual to facilitate communication or interaction as described herein. For example, individual clients 102 can utilize a mobile device with a software application that facilitates communication with one or more vehicles 104 and a network service 110. In other embodiments, the clients 102 can utilize multiple communication devices to access vehicles 104 and the network service 110, such as kiosks, tablet computing devices, personal computing devices, and the like.

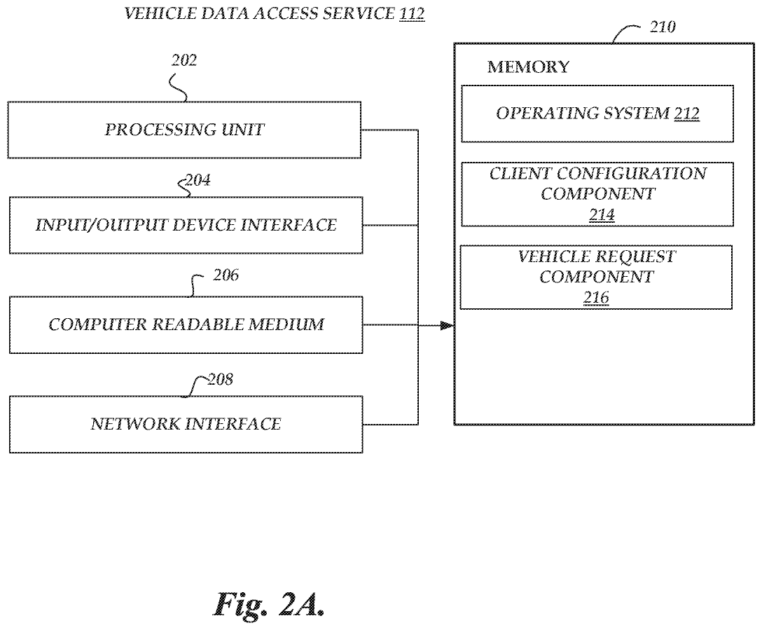

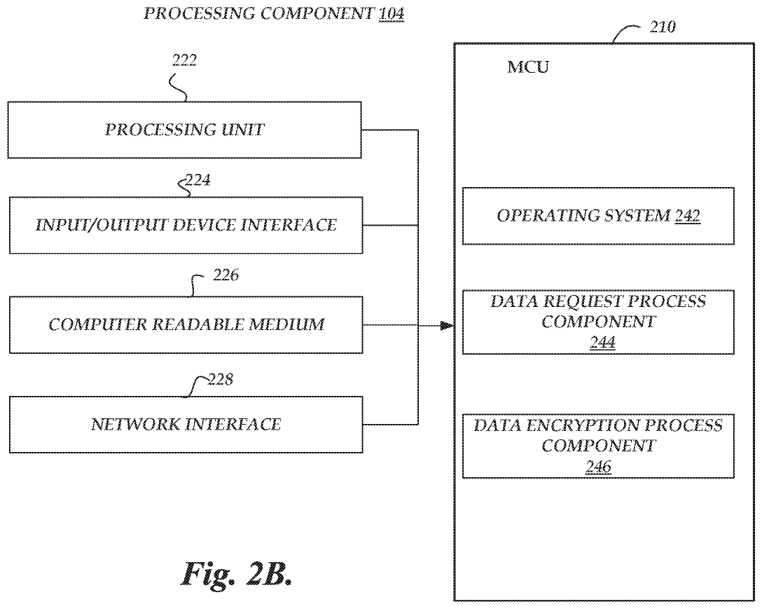

The environment 100 further includes a plurality of vehicles 104 (e.g., vehicles 104A, 104B, 104C) that communicate with the clients 102 and the network service 110 via a network connection. The vehicles include communication functionality, including hardware and software, that facilitate interaction via one of a plurality of communication mediums and communication protocols. An illustrative environment for a vehicle 104 will be illustrated with regard to FIG. 2B.

The network service 110 illustratively corresponds to a one or more computing devices that are operable to host a network vehicle data service 112 that can facilitate the interaction between individual clients 102 and individual selected vehicles 104 as described herein. The network service can further include one or more data stores. For example, data store 114 can be utilized to maintain encrypted profile data (e.g., client data) from clients 102, public keys from target vehicles 104, authentication information, authorization information, and any other information utilized in the exchange of profile information described herein. The network service 110 is represented in a simplified, logical form and does not reflect all of the physical software and hardware components that may be implemented to provide the functionality associated with the network-based service. Illustrative components for the network vehicle data service 112 will be described with regard to FIG. 2A.

With reference now to FIG. 2A, an illustrative architecture for implementing a vehicle data access service 112 on a network service provider 110 will be described. The vehicle data access service 112 may be part of components/systems that can provide functionality associated with processing and storing vehicle data and requesting an access to the vehicle data by communicating with the vehicle in bi-directional manner.

The architecture of FIG. 2A is illustrative in nature and should not be construed as requiring any specific hardware or software configuration for the processing component. The general architecture of a vehicle data access service 112 depicted in FIG. 2A includes an arrangement of computer hardware and software components that may be used to implement aspects of the present disclosure. As illustrated, the processing component includes a processing unit 202, a network interface 208, a computer readable medium 206, and an input/output device interface 204, all of which may communicate with one another by way of a communication bus. The components of the processing component may be physical hardware components that can include one or more circuitries and software models.

The network interface 208 may provide connectivity to one or more networks or computing systems, such as the networks 106 of FIG. 1. The processing unit 202 may thus receive information and instructions from other computing systems or services via a network. The processing unit 202 may also communicate to and from memory 210 and further provide output information via the input/output device interface. In some embodiments, the vehicle data access service 112 may include more (or fewer) components than those shown in FIG. 2A.

The memory 210 may include computer program instructions that the processing unit 202 executes in order to implement one or more embodiments. The memory 210 generally includes RAM, ROM, or other persistent or non-transitory memory. The memory 210 may store an operating system 212 that provides computer program instructions for use by the processing unit 202 in the general administration and operation of the vehicle data access service 112. The memory 210 may further include computer program instructions and other information for implementing aspects of the present disclosure. For example, in one embodiment, the memory 210 includes a client data configuration component 214. The client configuration component 216 can facilitate the generation of client profile data, processing rules, authentication procedures, authorization processes and the like. Illustratively, the user can provide permission to create a profile for requesting information and specific parameters/rules that are utilized in the transmission of vehicle data. This can include parameters regarding processing of requests, specification of rules for selecting vehicle data, specified or default duration of vehicle maintained in the network service provider, and the like. Some or a portion of the parameters may also be specified at the time of a request to share with a specific vehicle. The memory 210 can further include a vehicle request component 216. The vehicle request component 216 can receive and process requests from vehicles 104 to receive encrypted client data as described herein

With reference now to FIG. 2B, an illustrative architecture for implementing a processing component on a vehicle 104 will be described. The processing component may be part of components/systems that can provide functionality associated with processing and storing vehicle data and providing access to the stored data for a user by receiving the user's authorized information. The user may include but is not limited to an administrator, a developer, a service technician, a vehicle driver, etc.

The architecture of FIG. 2B is illustrative in nature and should not be construed as requiring any specific hardware or software configuration for the processing component. The general architecture of the of a vehicle 104 depicted in FIG. 2B includes an arrangement of computer hardware and software components that may be used to implement aspects of the present disclosure. As illustrated, the processing component includes a processing unit 222, a network interface 228, a computer readable medium 226, and an input/output device interface 224, all of which may communicate with one another by way of a communication bus. The components of the processing component may be physical hardware components that can include one or more circuitries and software models.

The network interface 228 may provide connectivity to one or more networks or computing systems, such as the network 106 of FIG. 1. The processing unit 222 may thus receive information and instructions from other computing systems or services via a network. The processing unit 222 may also communicate to and from a microcontroller unit (MCU) 210 and further provide output information via the input/output device interface 224. In some embodiments, a memory can be implemented to perform one or more functions of the MCU 210. In some embodiments, the processing component of the vehicle may include more (or fewer) components than those shown in FIG. 2B.

The MCU 210 may include computer program instructions that the processing component 220 executes in order to implement one or more embodiments. The MCU 210 generally includes RAM, ROM, or other persistent or non-transitory memory. The MCU 210 may store an operating system 242 that provides computer program instructions for use by the processing unit 222 in the general administration and operation of the processing component 220. The MCU 210 may further include computer program instructions and other information for implementing aspects of the present disclosure. For example, in one embodiment, the MCU 210 includes a data request process component 244. In some embodiments, the data request process component 244 can receive the data request and processes the data request to identify the requested data. Illustratively, the data request can specify the type, format and size of the requested data without limitation to a predefined or preconfigured format. Accordingly, in one embodiment, the data request process component 244 can include processing components that can parse received data requests, identify requested data and issue commands. In some embodiments, the data request process component 244 can collect and processes the requested information. Illustratively, the processing of the vehicle information can include filtering, normalization, averaging or other data processing. For example, the data request can include filtering criteria or other processing configuration information that facilitates the selection of vehicle data for processing. The MCU 210 may further include a data encryption process component 246.

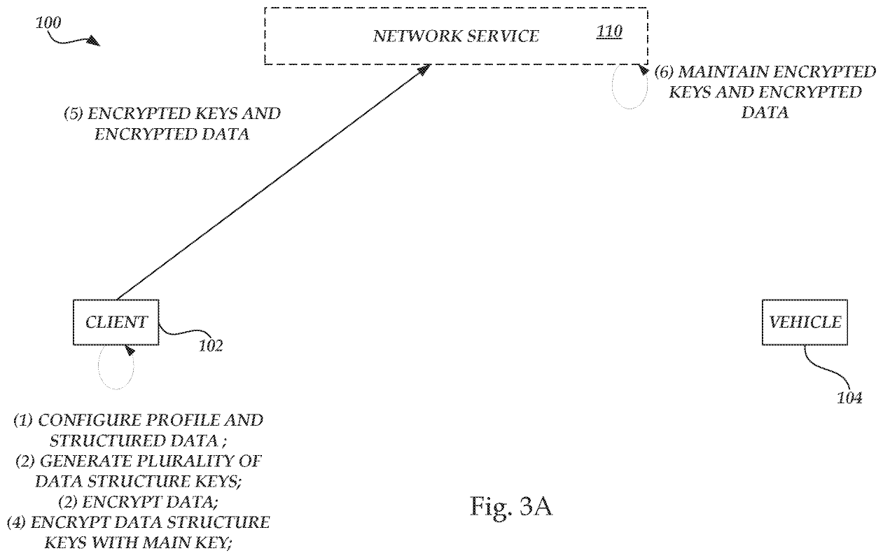

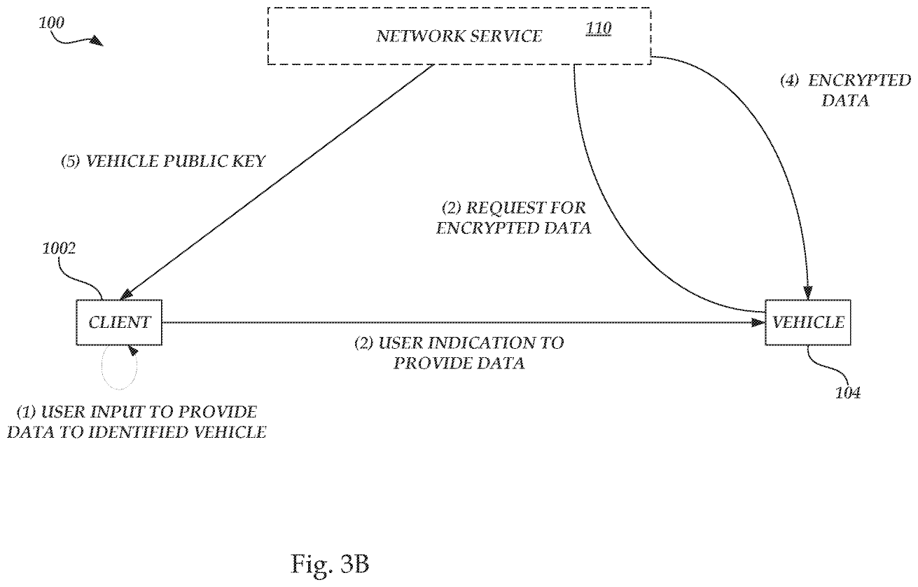

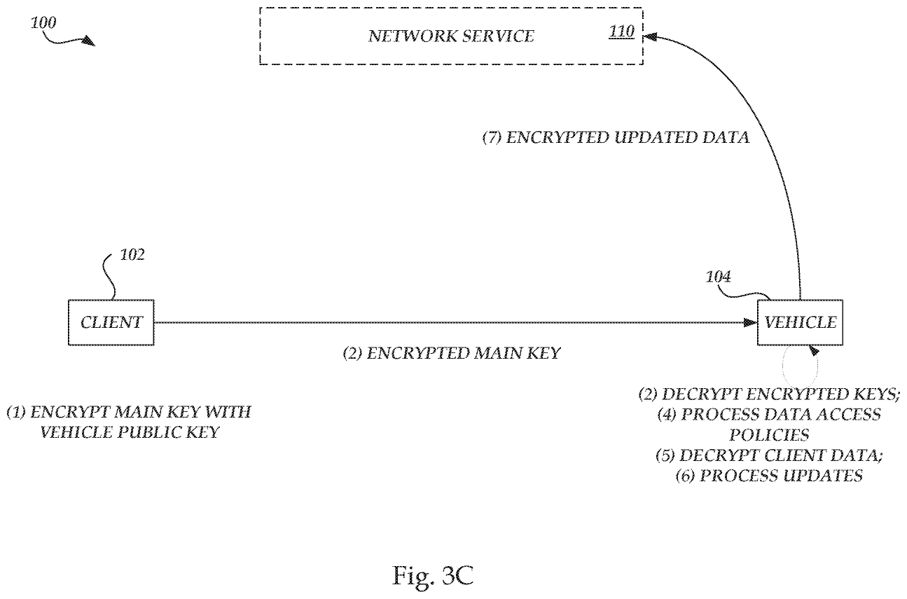

With reference now to FIGS. 3A-3C, an illustrative interaction between an individual client 102 wanting information to provide instructions/commands a target/selected vehicle 102 to receive profile information and the network service will be described. Although only a single interaction is illustrated, the present application is not limited to a single interaction between a client 102 and a target (or selected) vehicle 104. Rather, individual iterations of the illustrated interaction can result in different exchanges of profile information based on the specification of the client 102, configuration of the selected vehicle 104, and the like.

FIG. 3A illustrates an initial configuration of profile information. At (1), a client 102 through a mobile device, computing device, kiosk, or another vehicle, configures a profile and structured data for utilization in the profile. Illustratively, the client 102 can provide permission to create a profile for sharing and specific parameters/rules that are utilized in the sharing of profile information. This can include parameters regarding processing of requests, specification of rules for selecting shared profile information, specified or default duration of profile information maintained in the target vehicle 104, revocation rules for shared profile information, rules for updating of profile information by the target vehicle, and the like. Some or a portion of the parameters may also be specified at the time of a request to share with a specific, identified vehicle 104.

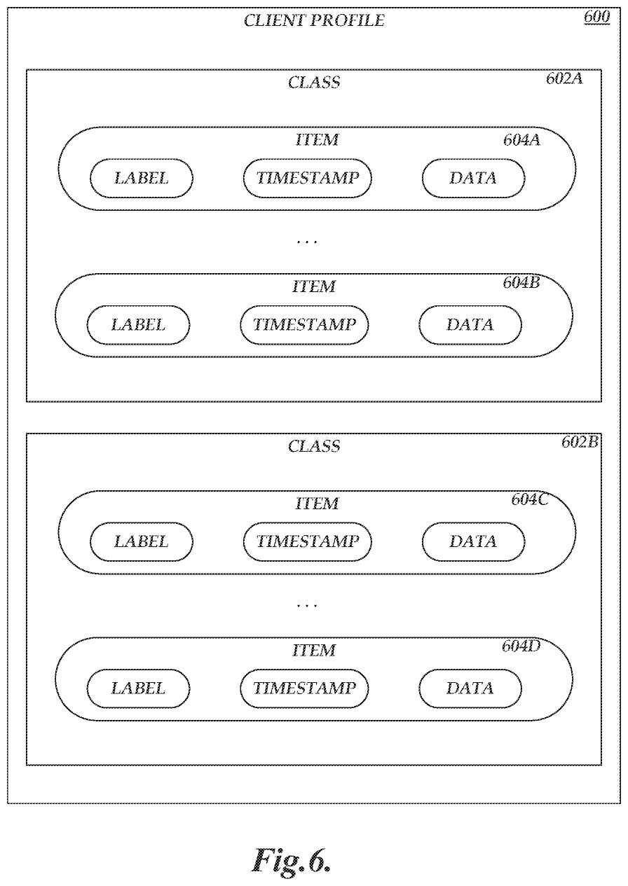

Illustratively, the vehicle/mobile device/computing device collects or generates the profile information according to structured data organizational criteria. Illustratively, the profile information can be organized into a set of individual classes and sub-classes. The classes of the profile information can be organized according to type of profile information or utilization of profile information, such as financial information, account information, usage information, customization/preferences, etc. Each sub-class, referred to as a label, can then include one or more data items related to the respective class (inherited) and defining one or more values for the subclass. Illustratively, an instantiation of an individual class can include multiple instantiations of labels (e.g., sub-classes). Each instantiation of a label includes individual profile information. Accordingly, rules to selectively transfer or utilize profile information can be based on the authorization by classes or rules related to individual classes. An illustration of the structured data is provided in FIG. 6.

At (2), the vehicle/mobile device generates a plurality of data structure keys to individually encrypt the structured profile data. More specifically, the profile information can be provided with a plurality of class encryption keys that allows for the encryption of each individual class of the profile information. Each individual sub-class may also be associated with a different or same key within a class to individually encrypt each sub-class, or label. Finally, a master data key will be utilized to encrypt the full selection of encrypted class data. As part of the roll up of encryption, the label keys are encrypted by the class key. The class keys are then encrypted by the master data key. Accordingly, at (3) and (4), the entirety of the data structure is encrypted and the keys utilized to encrypt the portions of the data structure are also encrypted.

At (5), the vehicle/mobile device transmits the encrypted keys and encrypted data to the network service without the master data key. At (6), the network service 110 maintains the encrypted information for utilization in sharing. However, because the master data key is not provided to the network service, it is not possible for the network service to access the encrypted data keys to decrypt the encrypted structured data. In some aspects, some portion of the data structure, such as the data identifiers, processing information, error checking information, etc. may remain unencrypted and accessible by the network service 110.

Turning now to FIG. 3B, to provide for sharing, at (1), a client 102 can provide specific input to select a target vehicle. The user input can be provided in a variety of forms, such as a user proximity to a selected vehicle, utilization of an app (such as a ride sharing app or taxi app) or utilizing search access via a network connection. At (2), the client 102 indication is provided to the target vehicle 104. As illustrated in FIG. 3B, the user indication may be provided utilizing a short-range radio communication, such as a Bluetooth connection, via a physical tether, or via a wide area network connection. As described above, the request or client indication can include the specification of parameters for profile information access. Such information can include parameters regarding processing of requests, specification of rules for selecting shared profile information, specified or default duration of profile information maintained in the target vehicle 1040, revocation rules for shared profile information, rules for updating of profile information by the target vehicle, and the like.

At (3), the selected vehicle can request the encrypted profile data from the network service, which provides the encrypted data at (4). Illustratively, the network service 110 may conduct additional processing or procedures related to the request. For example, the requesting vehicle 104 may be subject to authentication or authorization processes prior to accessing the encrypted data. Similarly, a client 102 attributed to the request may also be subject to authentication or authorization processes. Illustratively, the receipt of the encrypted data at the target vehicle is not usable because the vehicle does not have the master data key needed to decrypt the other data keys, which are then used to decrypt at least some portion of the encrypted data. At (5), the network service can provide a vehicle's public key, which will be utilized to exchange the required master key. In other embodiments, the vehicle and the client may directly exchange the vehicle's public key without need to utilize the network service. Illustratively, once encrypted with the recipient vehicle's public key, it will be assumed that only the target vehicle 104 should be able to decrypt and access the master key with the target vehicle's private key.

Turning now to FIG. 3C, at (1), the client 102 can encrypt the master key with the vehicle's public key such that only the vehicle 104 can decrypt the transmitted key with the corresponding private key that has not been exchanged or divulged by the vehicle. At (2), the client 102 transmits the encrypted master key, such as via the short-range radio connection, physical tether, network connection, etc. to the vehicle 104. At (3), the vehicle 104 can then decrypt the master key and encrypted data keys. At (4), the vehicle can then process any operational parameters specified for the vehicle, such as limiting the access to one or more classes of information, etc. At (5), the vehicle 104 decrypts the encrypted data and then process the profile information to update or configure one or more aspects of the vehicle as specified by the client 102.

At (6), in some embodiments, the selected vehicle can also obtain additional data to be added to the profile information, such as operational parameters, usage, preferences, etc. In this aspect, the vehicle 104 may not be provided access to all the keys (encrypted) for example, the network service 110 may be able to remove portions of the encrypted data (if encrypted in distinct portions) or otherwise obfuscate portions of the encrypted data. In other aspects, the processing rules can cause the vehicle 104 to delete one or more encryption keys or encrypted content that is not authorized to be accessed. Still further, in other aspects, the processing rules can cause the vehicle to delete any decrypted data or otherwise render portions of the data inaccessible. At (7), the updated information can be encrypted and sent to the network service similar to the process described with regard to FIG. 3A, although it can be implemented by the vehicle, client or combination since all the keys are accessible.

In some embodiments, if a revocation is received or indicated, the client/network service can transmit the command, which will cause the vehicle to cease utilizing the profile information and delete the information or otherwise render the information inaccessible. The illustrative interaction may be implemented multiple times based on vehicle data access parameters, permissions and requested actions. For example, the interaction may be implemented for portions of an encrypted data profile in accordance with a just-in-time basis (e.g., as needed or requested).

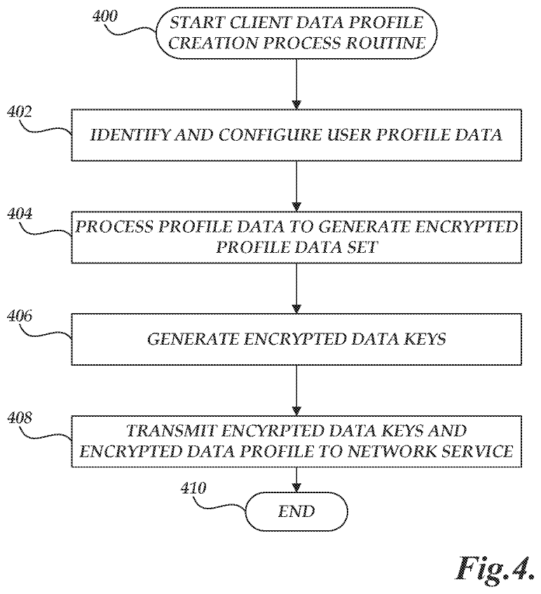

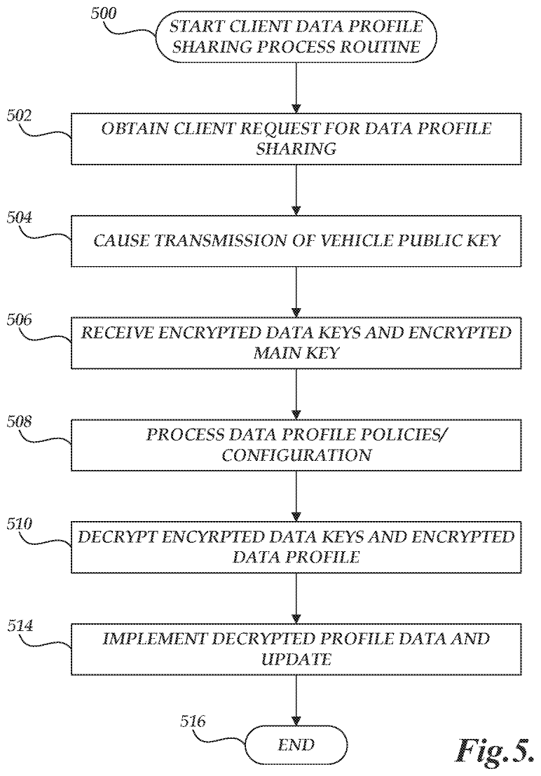

FIG. 4 illustrates a flow diagram of an illustrative process (as referenced in FIG. 3A) implemented by the client to provide encrypted data to a network service. FIG. 5 illustrates a flow diagram of an illustrative process (as referenced in FIGS. 3B and 3C) implemented by a vehicle to obtain encrypted data and the master key for processing. The processes illustrated in FIGS. 4 and 6 are illustrative in nature and should not be construed as limiting.

With reference to FIG. 4, at block 402, a client 102 through a mobile device, computing device, kiosk, or another vehicle, identifies and configures a profile and structured data for utilization in the profile. Illustratively, the client 102 can provide permission to create a profile for sharing and specific parameters/rules that are utilized in the sharing of profile information. This can include parameters regarding processing of requests, specification of rules for selecting shared profile information, specified or default duration of profile information maintained in the target vehicle 104, revocation rules for shared profile information, rules for updating of profile information by the target vehicle, and the like. Some or a portion of the parameters may also be specified at the time of a request to share with a specific, identified vehicle 104.

At block 404, the vehicle/mobile device/computing device collects or generates the profile information according to structured data organizational criteria. Illustratively, the profile information can be organized into a set of individual classes and sub-classes. The classes of the profile information can be organized according to type of profile information or utilization of profile information, such as financial information, account information, usage information, customization/preferences, etc. Each sub-class, referred to as a label, can then include one or more data items related to the respective class (inherited) and defining one or more values for the subclass. Illustratively, an instantiation of an individual class can include multiple instantiations of labels (e.g., sub-classes). Each instantiation of a label includes individual profile information. Accordingly, rules to selectively transfer or utilize profile information can be based on the authorization by classes or rules related to individual classes.

An illustration of the structured data is provided in FIG. 6. The data profile 600 is illustrated with a set of classes 602A, 602B in which each class has multiple subclasses 604. Still further, each subclass 604 (or item) includes client data, such as label data, timestamp data, or data. Other attributes or descriptors may be available as well.

At block 406, the vehicle/mobile device generates a plurality of data structure keys to individually encrypt the structured profile data. More specifically, the profile information can be provided with a plurality of class encryption keys that allows for the encryption of each individual class of the profile information. Each individual sub-class may also be associated with a different or same key within a class to individually encrypt each sub-class, or label. Finally, a master data key will be utilized to encrypt the full selection of encrypted class data. As part of the roll up of encryption, the label keys are encrypted by the class key. The class keys are then encrypted by the master data key. Accordingly, at (3) and (4), the entirety of the data structure is encrypted and the keys utilized to encrypt the portions of the data structure are also encrypted.

At block 408, the vehicle/mobile device transmits the encrypted keys and encrypted data to the network service without the master data key. Routine 400 terminates at block 410.

With reference to FIG. 5, at block 502, a client 102 indication is provided to the target vehicle 104. The user input can be provided in a variety of forms, such as a user proximity to a selected vehicle, utilization of an app (such as a ride sharing app or taxi app) or utilizing search access via a network connection. As illustrated in FIG. 3B, the user indication may be provided utilizing a short-range radio communication, such as a Bluetooth connection, via a physical tether, or via a wide area network connection. As described above, the request or client indication can include the specification of parameters for profile information access. Such information can include parameters regarding processing of requests, specification of rules for selecting shared profile information, specified or default duration of profile information maintained in the target vehicle 1040, revocation rules for shared profile information, rules for updating of profile information by the target vehicle, and the like.

At block 504, the vehicle can provide a vehicle's public key, which will be utilized to exchange the required master key. As previously described, the vehicle and the client may directly exchange the vehicle's public key without need to utilize the network service. In other embodiments, this process may be omitted. Illustratively, once encrypted with the recipient vehicle's public key, it will be assumed that only the target vehicle 104 should be able to decrypt and access the master key with the target vehicle's private key.

Illustratively, the selected vehicle can request the encrypted profile data from the network service. Additionally, the client 102 can encrypt the master key with the vehicle's public key such that only the vehicle 104 can decrypt the transmitted key with the corresponding private key that has not been exchanged or divulged by the vehicle. At block 506, the vehicle receives the encrypted data and encrypted encryption keys. For example, the client 102 can transmit the encrypted master key, such as via the short-range radio connection, physical tether, network connection, etc. to the vehicle 104.

At block 508 the vehicle can then process any operational parameters specified for the vehicle, such as limiting the access to one or more classes of information, etc. At block 510, the vehicle 104 can then decrypt the master key and encrypted data keys. Additionally, the vehicle 104 decrypts the encrypted data and then process the profile information to update or configure one or more aspects of the vehicle as specified by the client 102. At block 512, the vehicle can implement the decrypted profile data in accordance with processing rules or data access requirements.

Illustratively, in some embodiments, the selected vehicle can also obtain additional data to be added to the profile information, such as operational parameters, usage, preferences, etc. In this aspect, the vehicle 104 may not be provided access to all the keys (encrypted) for example, the network service 110 may be able to remove portions of the encrypted data (if encrypted in distinct portions) or otherwise obfuscate portions of the encrypted data. In other aspects, the processing rules can cause the vehicle 104 to delete one or more encryption keys or encrypted content that is not authorized to be accessed. Still further, in other aspects, the processing rules can cause the vehicle to delete any decrypted data or otherwise render portions of the data inaccessible. At block 514, the routine terminates.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed air vent assembly. It is to be understood that the forms of disclosure herein shown and described are to be taken as representative embodiments. Equivalent elements, materials, processes, or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application.

What is claimed:

1. A system for managing access to vehicle data, the system having a vehicle data access component comprising:
one or more computing processors and memories associated with a vehicle data access service, wherein the vehicle data access service is configured to:
obtain a client request for data profile information access, wherein the client request for data profile information access is directed to an identified vehicle;
receive a set of encrypted data from a network service, the set of encrypted data including at least one encrypted data profile information and at least one encrypted data key, wherein the encrypted data profile information is encrypted with the encrypted data keys, and wherein the at least one encrypted data keys are encrypted with a vehicle public key;
decrypt the at least one encrypted data key with a vehicle private key to access the at least one encrypted data keys, wherein the vehicle private key is complimentary to the vehicle public key; and
decrypt at least a portion of the encrypted data profile information using the at least one decrypted data key to access the at least a portion of the data profile information.

2. The system as recited in claim 1, wherein the vehicle data access component obtains the client request via a detected proximity.

3. The system as recited in claim 1, wherein the vehicle data access component obtains the client request via a transmitted client request.

4. The system as recited in claim 1, wherein the vehicle data access component transmits the vehicle public key to the client.

5. The system as recited in claim 1, wherein the vehicle data access component transmits the vehicle public key to the network service to transmit to one or more clients.

6. The system as recited in claim 1, wherein the data profile information is organized as one or more individual classes, wherein each individual class can include one or more sub-classes.

7. The system as recited in claim 6, wherein the encrypted data keys include a data key for encrypting data associated with an individual class of the data profile information.

8. The system as recited in claim 7, wherein the encrypted data keys include a data key for encrypted data associated with an individual sub-classes of a respective class, wherein the data key associated with the sub-class is encrypted with the data key associated with the respective class.

9. The system as recited in claim 1, wherein the vehicle data access component is further configured to process the at least a portion of the data profile according to one or more processing rules.

10. The system as recited in claim 1, wherein the vehicle data access component is further configured to process a revocation command to prevent subsequent access to the at least a portion of the data profile information.

11. A method for managing data access in a vehicle comprising:
obtaining a client request for data profile information access, wherein the client request for data profile information access is directed to an identified vehicle;
receiving a set of encrypted data from a network service, the set of encrypted data including at least one encrypted data profile information and at least one encrypted data key, wherein the encrypted data profile information is encrypted with the encrypted data keys, and wherein the at least one encrypted data keys are encrypted with a vehicle public key;
decrypting the at least one encrypted data key with a vehicle private key to access the at least one encrypted data keys, wherein the vehicle private key is complimentary to the vehicle public key;
decrypting at least a portion of the encrypted data profile information using the at least one decrypted data key to access the at least a portion of the data profile information;
causing access to the at least a portion of the encrypted data profile information.

12. The method as recited in claim 11, wherein obtaining a client request for data profile information access includes obtaining the client request via at least one of a detected proximity or a transmitted client request.

13. The method as recited in claim 11 further comprising transmitting the vehicle public key to the client.

14. The method as recited in claim 11, wherein the data profile information is organized as one or more individual classes, wherein each individual class can include one or more sub-classes.

15. The method as recited in claim 14, wherein the encrypted data keys include a data key for encrypting data associated with an individual class of the data profile information.

16. The method as recited in claim 15, wherein the encrypted data keys include a data key for encrypted data associated with an individual sub-classes of a respective class, wherein the data key associated with the sub-class is encrypted with the data key associated with the respective class.

17. The method as recited in claim 11 further comprising processing the at least a portion of the data profile according to one or more processing rules.

18. The method as recited in claim 11 further comprising processing a revocation command to prevent subsequent access to the at least a portion of the data profile information.

19. A method for managing data access in a vehicle comprising:
obtaining a client request for data profile information access, wherein the client request for data profile information access is directed to an identified vehicle, wherein the data profile information is organized as one or more individual classes, wherein each individual class can include one or more sub-classes;
receiving a set of encrypted data from a network service, the set of encrypted data including at least one encrypted data profile information and at least one encrypted data keys, wherein the encrypted data profile information is encrypted with the encrypted data keys, wherein the encrypted data keys includes a data key for encrypting data associated with an individual class of the data profile information and wherein the at least one encrypted data keys are encrypted with a vehicle public key;
decrypting the at least one encrypted data key with a vehicle private key to access the at least one encrypted data keys, wherein the vehicle private key is complimentary to the vehicle public key; and
decrypting at least a portion of the encrypted data profile information using the at least one decrypted data key to access the at least a portion of the data profile information.

20. The method as recited in claim 19, wherein the encrypted data keys include a data key for encrypted data associated with an individual sub-classes of a respective class, wherein the data key associated with the sub-class is encrypted with the data key associated with the respective class.

21. The method as recited in claim 19, further comprising processing the at least a portion of the data profile according to one or more processing rules.

22. The method as recited in claim 19, further comprising processing a revocation command to prevent subsequent access to the at least a portion of the data profile information.
